(19) United States
(12) Patent Application Publication
(10) Pub. No.: US 2007/0027999 A1
(43) Pub. Date: Feb. 1, 2007

(54) Method for coordinated error tracking and reporting in distributed storage systems

(76) Inventors: James Patrick Allen, Austin, TX (US); Matthew Joseph Kalos, Tucson, AZ (US); Thomas Stanley Mathews, Austin, TX (US); Lance Warren Russell, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/193,841

(22) Filed: Jul. 29, 2005

(51) Int. Cl. G06F 15/173

(52) U.S. Cl. 709/238

(57) ABSTRACT

A system for coordinating error tracking, level setting and reporting among the various layers/components of a distributed storage system. Each component of the distributed system includes a trigger generation and response (TGR) utility, which generates an error tracking trigger (ETT), comprising: (1) an action that the initiator wants the stack's error tracking mechanisms to take; (2) a message that the initiator wants the stack to immediately post in its logs; and (3) a route/direction that the trigger is to be transmitted through the stack. The ETT is transmitted one layer at a time through the stack, and each intervening layer of the stack is equipped with a utility to examine the ETT and take the appropriate action(s), designated by the trigger. An error log is maintained by each layer of the stack and used to record information about the error and enable user determination of the source, timing and cause of errors.

### BACKGROUND OF THE INVENTION

1. Technical Field

The present invention relates generally to computer systems and in particular to distributed storage systems. Still more particularly, the present invention relates to a method and system for improving error analysis and reporting in computer systems that include distributed storage systems.

2. Description of the Related Art

Distributed storage systems are being more commonly utilized in the computer industry. Over the last several years, significant changes have occurred in how persistent storage devices are attached to computer systems. With the introduction of Storage Area Networks (SANS) and Network Attached Storage (NAS) technologies, storage devices have evolved from locally attached, low capability, passive devices to remotely attached, high capability, active devices that are capable of deploying vast file systems and file sets.

As the storage devices and infrastructure become more and more distributed, isolating and correcting errors that occur within the distributed system becomes much more difficult. While a system administrator or monitoring component is made aware of the error, it is not easy to determine where within the distributed system the error actually occurred. The administrator is forced to implement a time consuming device-by-device analysis to determine whether the error occurred in the database, the file system, the storage device driver, the network connecting the distributed storage to the host system, or the distributed storage server.

A major contributing factor to the problem with conventional error resolution within a distributed system is the fact that error tracking and reporting in distributed storage systems is not coordinated. When a problem is detected on the host system, the occurrence/detection of the problem is not conveyed to the storage server(s). As a result, error tracking and logging may not even be turned on at the storage server(s). Conversely, when an error is detected at a storage server, the error is not reported to the host system, and error tracking and logging is not turned on at the host system.

Notably, even if tracking is turned on at both the storage server and the host system, it may be impossible to correlate events because the time stamps at each system differ. Additionally, the target and/or level of tracking at the host system and storage server may be incompatible. As an example, the host may be tracking storage writes at the highest level of detail while the storage server logs only the fact that a write to the device has occurred.

There are several current procedures for collating system trace and error logs in a distributed computing environment. Among these procedures are ones created by “syslog” a program utility introduced in BSD 4.2 and available on most Unix variants (e.g., AIX, Solaris, Linux) and “streams,” another program utility originally introduced as part of AT&T System V UNIX. Syslog provides a set of procedures that are not storage system specific. Streams provides a mechanism that enables a message to bi-directionally transverse a stack. However, the mechanism is not applied to error tracking and reporting.

U.S. Patent application, No. 20020188711, titled “Failover Processing in a Storage System,” provides policies for managing fault tolerance and high availability configurations. The approach encapsulates the knowledge of failover recovery between components within a storage server and between storage server systems. The encapsulated knowledge includes information about what components are participating in a Failover Set, how they are configured for failover, what is the Fail-Stop policy, and what are the steps to perform when “failing-over” a component. However, there is no mechanism for tracking errors across the entire storage system.

The present invention recognizes the above limitations in tracking and recording errors occurring in distributed storage systems, and the invention details a method to coordinate error tracking, level setting and reporting among the components of a distributed storage system that resolves the above described problem. These and other benefits are provided by the invention described herein.

### SUMMARY OF THE INVENTION

Disclosed is a method and system for coordinating system-wide, error tracking, level setting and reporting among the components of a distributed storage system. These functions are initiated via a single trigger operation. Each component of the distributed system, e.g., the host system(s) and storage server(s), includes a trigger generation and response (TGR) utility, which generates an error tracking trigger (ETT). ETT comprises three primary sub-components: (1) a representation of the action that the initiator wants the stack error tracking mechanisms to take (e.g., start error logging for a specific target at a specific level of detail); (2) a message containing human readable data that the initiator wants the stack to immediately post in its logs; and (3) a route, representing the direction (to the host or to the storage server) that the trigger is to be transmitted through the stack.

TGR utility provides a software interface utilized to construct and transmit the error tracking trigger (ETT). The interface is accessible to all components of the stack and all host system applications with the appropriate permissions. The ETT is initialized by either host system applications and/or any layer of the stack, and the ETT is transmitted one layer at a time through the stack. Each intervening layer of the stack is designed/provided with a utility to examine the ETT and take the appropriate action(s) designated by the trigger. An error log is also maintained by each layer of the stack to record information about the error. User access is provided to these logs, and the user/administrator is able to review log entries immediately before and after the message for unusual events, and determine the source, timing and cause of errors. Accordingly, distributed tracking and logging of errors within the storage system is coordinated to track specific targets at a specific level of detail.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A is a diagram of a distributed network having distributed storage connected to host systems, within which embodiments of the invention may advantageously be implemented;

FIG. 1B is a block diagram of an exemplary host system with software utility for generating a trigger and responding to receipt of a query, according to one embodiment of the invention;

FIG. 2 is a flow diagram of the processes involved in completing a write from an application on the host system to a persistent storage according to one embodiment of the invention;

FIG. 3A illustrates component parts of an exemplary trigger according to one embodiment of the invention;

FIG. 3B is a flow diagram of the creation and use of a trigger to initiate evaluations of each individual component within the entire distributed system, according to one embodiment of the invention; and

FIG. 4 is a flow chart illustrating the process undertaken by one or more of the various components when the component receives a trigger, in accordance with one embodiment of the present invention.

### DETAILED DESCRIPTION OF AN ILLUSTRATIVE EMBODIMENT

The present invention provides a method and system for coordinating error tracking, level setting and reporting among the various layers/components of a distributed storage system via a single trigger operation. Each component of the distributed system includes a trigger generation and response (TGR) utility, which generates an error tracking trigger (ETT). ETT comprises three primary sub-components: (1) an action that the initiator wants the stack's error tracking mechanisms to take; (2) a message containing human readable data that the initiator wants the stack to immediately post in its logs; and (3) a route, representing the direction that the trigger is to be transmitted through the stack. The ETT is transmitted one layer at a time through the stack, and each intervening layer of the stack is equipped with a utility to examine the ETT and take the appropriate action(s), designated by the trigger. An error log is maintained by each layer of the stack and used to record information about the error and enable user determination of the source, timing and cause of errors.

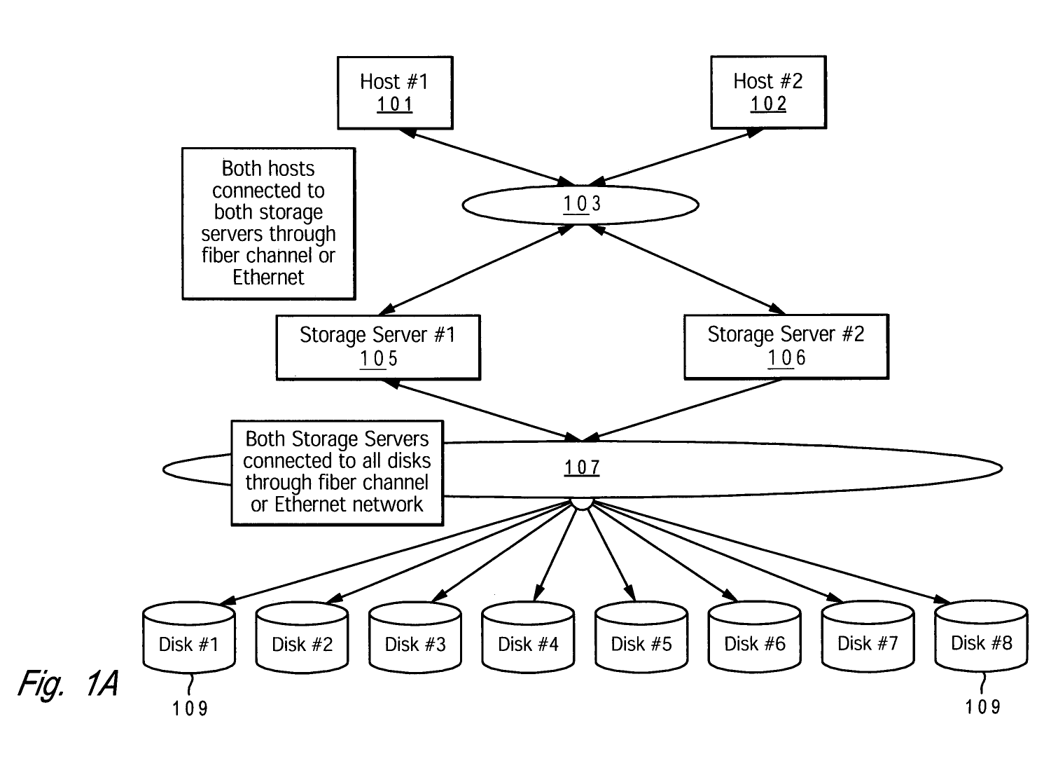

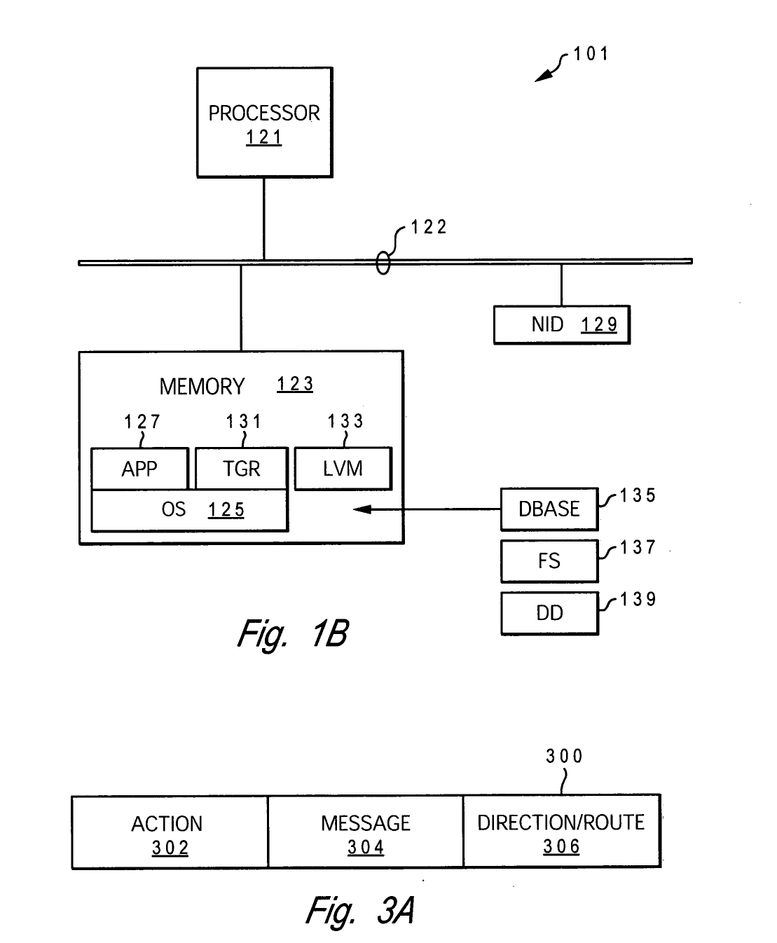

FIG. 1A illustrates an exemplary embodiment of the topology of a distributed storage system, within which the various features of the invention may advantageously be implemented. As shown by FIG. 1A, distributed storage system comprises one or more host systems (for example, host systems 101 and 102) connected to one or more storage servers (for example, servers 105 and 106) via a first internal/external network 103. Storage servers 105/106 are themselves connected to persistent storage devices (disks) 109 via a second internal/external network 107. Both first network 103 and second network 107 comprise some combination of fiber channels or Ethernet or other network structure based on system design.

While FIG. 1A illustrates only two hosts (101 and 102) connected to two storage servers (105 and 106) using fiber channel, it is understood that any number of host systems and/or storage systems may exist within the distributed storage system. Also, while storage servers 105/106 are themselves connected to eight disks via another fiber channel network, the number of disks (or persistent storage devices) is variable and not limited by the illustration. Finally, the invention is independent of the physical network media connecting the components. For example, all of the fiber channel networks could be replaced with Ethernet networks or other network connection medium.

With reference now to FIG. 1B, there is illustrated a block diagram representation of an exemplary host system, which for illustration is assumed to be host system 101. Host system 101 is a typical computer system that includes a processor 121 connected to local memory 123 via a system bus 122. Within local memory 123 are software components, namely operating system (OS) 125 and application programs 127. According to the invention, host system 101 also includes the required hardware and software components to enable connection to and communication with a distributed storage network (e.g., network interface device, NID 129).

Additionally, host system 101 includes a trigger generation and response (TGR) utility 131 and logical volume manager (LVM) 133 (within the illustrated embodiment), which along with other software components executing on each device within the connected distributed storage network, enables the various functional features of the invention. Specifically, TGR utility 131 generates a software construct referred to herein as an error tracking trigger (ETT), which is described in greater details below.

From a distributed storage network-level view, applications, such as databases 135 and file systems 137, execute on the host system 101 accessing virtualized storage pools (not shown). These storage pools are constructed by the hosts system(s) using file systems and/or logical volume managers and are physically backed by actual storage residing at one or more of the storage servers. As applications issue input/output (I/O) operations to the storage pools, these requests are passed through the host file system 137, host logical volume manager 131, and host device drivers 139.

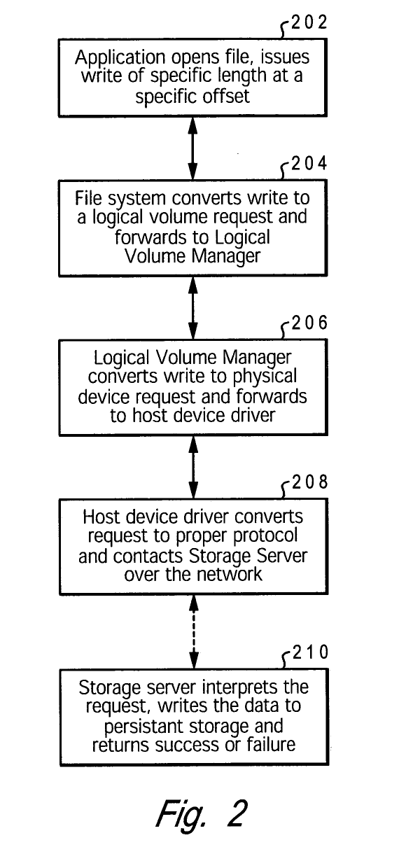

FIG. 2 illustrates the processes that occur following issuance of a write at the host system and write-processing at the storage server. Beginning at block 202, an application executing on the host system opens a file and issues a write of a specific length at a specific offset. At block 204, the file system converts the write to a logical volume request and then forwards the request to the logical volume manager. The logical volume manager converts the write to a physical device request and forwards the write to a host device driver, a shown at block 206. Following, the host device driver converts the request to a proper protocol and transmits the request over the network to the storage server(s), as depicted at block 208. Finally, at the storage server, the request is interpreted and routed to the appropriate storage server module (disk or other persistent storage device), as shown at block 210. Notably, block 210 also indicates that the storage server returns a response indicating success or failure of the request.

For the purposes of the invention, the above described processing pipeline (host file system, host logical volume manager, host device driver, storage network protocol and storage server modules) are collectively referred to as the distributed storage system software stack. It is noted, however, that the described software stack is a logical definition of the software stack presented for illustration only. Certain implementations may not contain all of the above components explicitly or may contain additional/different named components providing similar functional features. For example, some operating systems which implement the features of the invention may not have a logical volume manager, but rather combine the function (of an LVM) with the file system. Those skilled in the art appreciate that the functional features of the invention are applicable to any of the different logical configurations of the software stack.

According to one embodiment, a software interface is constructed for the purpose of constructing and transmitting the error tracking trigger (ETT). This interface is accessible to all components of the stack and all host system applications with the appropriate permissions. The interface is synonymous with or a component part of trigger generation and response (TGR) utility 131. Thus, the invention applies to file systems and data bases. Notably, a general application of the features of the invention enables the initialization of a trigger by either host system applications and/or any layer of the stack.

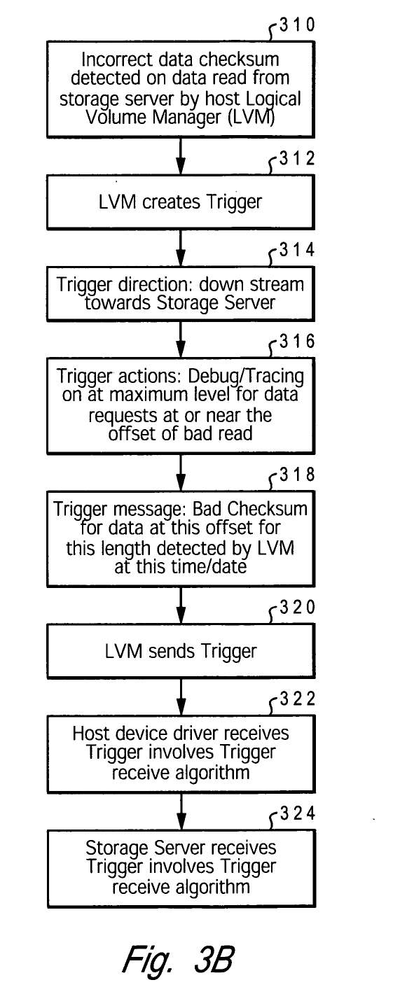

An exemplary ETT is illustrated by FIG. 3A. As shown, ETT 300 is a message/communication module that includes a minimum of three primary sub-components. The first primary sub-component of the ETT 300 is referred to as the action 302 and represents an action that the initiator wants the stack error tracking mechanisms to take. Typically, this action is to start error logging for a specific target at a specific level of detail. The second primary sub-component of the ETT 300 is referred to as the message 304, and contains some human readable data that the initiator wants the stack to immediately post in its logs. The third primary sub-component is the route 306, which represents the direction (to the host or to the storage server) that the trigger is to be transmitted through the stack.

FIG. 3B illustrates the process by which an ETT 300 is created at and transmitted from a host. It should be noted that while the below description refers specifically to processes originating at the host, that this illustration is for illustration only, as the error detection and creation/generation of the error trigger may occur at any component within the software stack. For example, a data base may observe the error and generate the trigger, or the storage server may observe the error and generate the trigger. References to host-level processes throughout the application and within the claims and drawings are thus not intended to impose any limitations on the invention.

Returning to FIG. 3B, the process begins at block 310, which depicts the detection (by the host’ logical volume manager (LVM), for example) of an incorrect data checksum associated with data that is read from the storage server. In response, the LVM activates TGR utility at block 312. The creation of specific sub-components and their associated functionality within the trigger are illustrated within blocks 314, 316, and 318. At block 314, the trigger generation utility programs the direction as downstream, towards the storage server (rather than upstream from the server to the host). The trigger is issued from the host and travels towards the storage server via the network using the direction component within the trigger. The trigger generation utility then programs the action which, as illustrated at block 316, includes turning a debug/tracking on at a maximum level for data requests at or near the offset of a bad read. As indicated by block 318, the trigger generation utility programs a message indicating that a bad checksum for data at the particular storage server (identified by its offset address) for the length was detected by the LVM at a particular time/date.

Once the ETT is completed, the LVM issues the ETT, as shown at block 320, and the host's device driver receives the trigger and invokes a trigger receive/send algorithm, indicated by block 322. Then, the trigger is transmitted to the storage server, which invokes a trigger receive algorithm when the server receives the trigger, as indicated at block 324. Notably, the trigger receive algorithm is invoked by each layer of the stack.

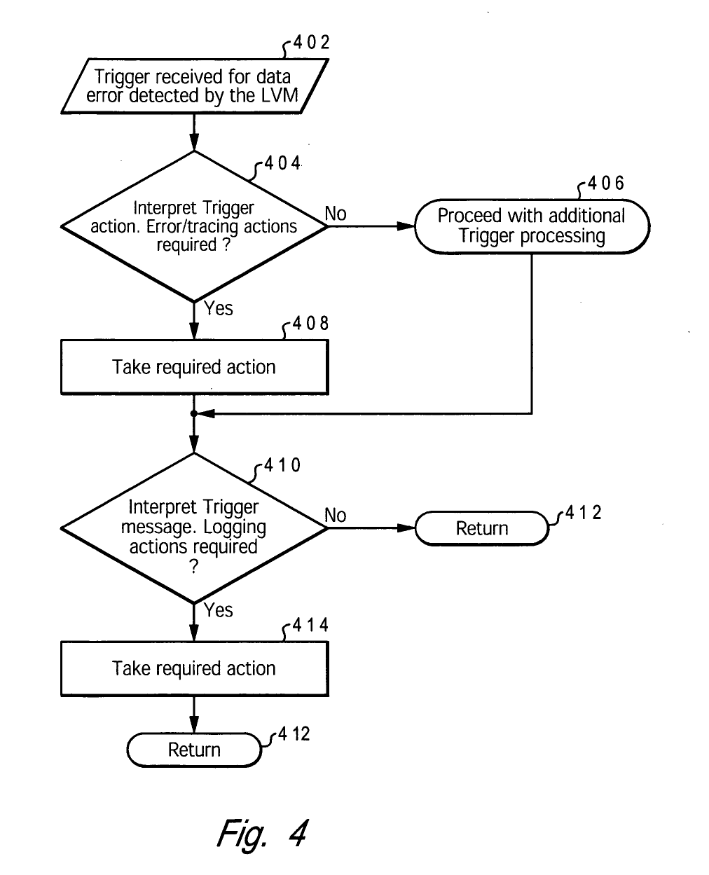

FIG. 4 illustrates the processes undertaken by the host system on receipt of the trigger. The process begins at block 402 with the trigger received for data error detected by the LVM. At block 404, the LVM interprets the action component of the trigger and determines whether an error tracking action is required. If no error tracking action is required, the LVM proceeds with additional trigger processing, as indicated at block 406. If, however, error tracking action is required, LVM implements the required action, as shown at block 408.

Following, at block 410, the message within the trigger is interpreted and a determination made whether the error information should be recorded within an error log maintained by the destination component (i.e., the host system in the present example). Each component maintains an error log utilized for storing relevant information about errors that are encountered. If the error information is not of the type that is required to be placed in the error log, the process ends at block 412. If the error information is required to be logged, however, the required information about the error is recorded within the log, as indicated at block 414, and then the process ends at bock 412.

Once the trigger arrives at the storage server, the trigger message is read by the server. The interface composes the trigger and initiates the trigger's transmission through the stack in the designated direction. The trigger is transmitted one layer at a time so that each intervening layer of the stack can examine the trigger and take appropriate actions. As the layers of the stack take the action designated by the trigger, the distributed tracking and logging of the system becomes coordinated, and tracks a specific target at a specific level of detail. Additionally, as each layer of the stack posts the message to its log, the problem of correlating disparate system logs is resolved. Readers are able to review log entries immediately before and after the message for unusual events, in order to determine the source, timing and cause of errors.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a distributed storage system having a first component at a first layer connected to a second component at a second layer via an interface, a method comprising:
detecting, at the first component of the distributed storage system, an error associated with data at the second component of the distributed storage system;
activating a response utility to generate a software response trigger;
issuing the software response trigger to the interface to traverse the interface across each layer of the distributed storage system;
instantiating, via the issuing of the software response trigger to the interface, a response within each layer of the distributed storage system wherein coordinated information about the error is shared with each layer and an action in response to the error is provided within each layer.

2. The method of claim 1, wherein the software response trigger is an error tracking trigger (ETT) that includes:
a first information set that indicates a direction in which the ETT traverses the interface to each layer, wherein when the ETT is generated at a host system, the first information set is programmed to route the ETT in the direction of a storage server, and when the ETT is generated at the storage server, the first information set is programmed to route the ETT in the direction of the host system(s);
a second information set that indicates the action that is to be completed at each layer in response to the occurrence of the error; and
a third information set that provides a message indicating that an error was detected for data at the particular component at which the error is detected.

3. The method of claim 2, wherein the third set of information includes one or more of an offset address associated with the particular component and a particular time/date at which the error is detected.

4. The method of claim 2, wherein the action includes turning a debug/tracking function on at a maximum level for data requests at or near the offset of a bad read.

5. The method of claim 1, wherein the error is an incorrect data checksum.

6. The method of claim 1, wherein the detecting is completed by a filesystem construct, including a logical volume manager (LVM), and includes:
dynamically activating a trigger response and generation (TRG) utility when the error is detected; and
issuing the ETT to a device driver to transmit to the second component;
automatically invoking a trigger receive/send algorithm; and
transmitting the ETT to the second component, wherein the second component automatically invokes a trigger receive algorithm when the second component receives the ETT.

7. The method of claim 6, wherein said transmitting step comprises transmitting said ETT to each layer within the software stack, wherein a trigger receive algorithm is invoked by each layer of the stack and each layer implements the appropriate action indicated within the ETT.

8. The method of claim 1, further comprising:
providing each layer with a trigger receive/send algorithm that is automatically activated when an ETT traverses that layer of the stack and which implements the appropriate action indicated within the ETT and stores the message information provided by the ETT within a log maintained by that layer.

9. The method of claim 1, further comprising:
on receipt of the ETT at each intervening layer and by the second component, evaluating the second information set of the ETT to determine whether an action is required; and
when an action is required, implementing the required action provided within the second information set at each intervening layer and at the second component.

10. The method of claim 9, further comprising:
creating a log entry of the error and corresponding action when a pre-defined criterion for logging the error and corresponding action is met; and
enabling user access to the log of each layer of the stack, such that said user is able to review log entries immediately before and after the message for unusual events, and determine the source, timing and cause of each recorded error.

11. A distributed storage system comprising:
a plurality of layers within a software stack, each representing a specific device, wherein a first component is represented by a first layer and is connected, via an interface, to a second component that is represented by a second layer;
logic provided within the first component for:
detecting an error associated with data at the second component of the distributed storage system;
activating a response utility to generate a software response trigger;
issuing the software response trigger to the interface to traverse the interface across each layer of the distributed storage system;
instantiating, via the issuing of the software response trigger to the interface, a response within each layer of the distributed storage system wherein coordinated information about the error is shared with each layer and an action in response to the error is provided within each layer.

12. The distributed storage system of claim 11, wherein the software response trigger is an error tracking trigger (ETT) that includes:
a first information set that indicates a direction in which the ETT traverses the interface to each layer, wherein when the ETT is generated at a host system, the first information set is programmed to route the ETT in the direction of a storage server, and when the ETT is generated at the storage server, the first information set is programmed to route the ETT in the direction of the host system(s);
a second information set that indicates the action that is to be completed at each layer in response to the occurrence of the error; and
a third information set that provides a message indicating that an error was detected for data at the particular component at which the error is detected.

13. The distributed storage system of claim 12, wherein:
the third set of information includes one or more of an offset address associated with the particular component and a particular time/date at which the error is detected; and
the action includes turning a debug/tracking function on at a maximum level for data requests at or near the offset of a bad read.

14. The distributed storage system of claim 11, wherein the logic for detecting includes logic for:
dynamically activating a trigger response and generation (TRG) utility when the error is detected; and
issuing the ETT to a device driver to transmit to a the second component;
automatically invoking a trigger receive/send algorithm; and
transmitting the ETT to the second component, wherein the second component automatically invokes a trigger receive algorithm when the second component receives the ETT,
wherein further said logic for completing the transmitting comprises logic for:
providing each layer with a trigger receive/send algorithm that is automatically activated when an ETT traverses that layer of the stack and which implements the appropriate action indicated within the ETT and stores the message information provided by the ETT within a log maintained by that layer; and
transmitting said ETT to each layer within the software stack, wherein a trigger receive algorithm is invoked by each layer of the stack and each layer implements the appropriate action indicated within the ETT.

15. The distributed storage system of claim 11, further comprising logic for:
on receipt of the ETT at each intervening layer and by the second component, evaluating the second information set of the ETT to determine whether an action is required;
when an action is required, implementing the required action provided within the second information set at each intervening layer and at the second component;
creating a log entry of the error and corresponding action when a pre-defined criterion for logging the error and corresponding action is met; and
enabling user access to the log of each layer of the stack, such that said user is able to review log entries immediately before and after the message for unusual events, and determine the source, timing and cause of each recorded error.

16. A computer program product comprising:
a computer readable medium; and
program code on the computer readable medium for:
detecting, at a first component of a distributed storage system, an error associated with data at a second component of the distributed storage system, wherein the distributed storage system has a plurality of layers that include a first layer representing the first component and a second layer representing the second component, which is connected to the first component via an interface;
activating a response utility to generate a software response trigger;
issuing the software response trigger to the interface to traverse the interface across each layer of the distributed storage system;
instantiating, via the issuing of the software response trigger to the interface, a response within each layer of the distributed storage system wherein coordinated information about the error is shared with each layer and an action in response to the error is provided within each layer.

17. The computer program product of claim 16, wherein the software response trigger is an error tracking trigger (ETT) that includes:
a first information set that indicates a direction in which the ETT traverses the interface to each layer, wherein when the ETT is generated at a host system, the first information set is programmed to route the ETT in the direction of a storage server, and when the ETT is generated at the storage server, the first information set is programmed to route the ETT in the direction of the host system(s);
a second information set that indicates the action that is to be completed at each layer in response to the occurrence of the error; and
a third information set that provides a message indicating that an error was detected for data at the particular component at which the error is detected.

18. The computer program product of claim 16, wherein the program code for detecting includes code for:
dynamically activating a trigger response and generation (TRG) utility when the error is detected; and
issuing the ETT to a device driver to transmit to a the second component;
automatically invoking a trigger receive/send algorithm; and
transmitting the ETT to the second component, wherein the second component automatically invokes a trigger receive algorithm when the second component receives the ETT, wherein said transmitting code transmits said ETT to each layer within the software stack, wherein each layer is provided with a trigger receive/send algorithm that is automatically activated when an ETT traverses that layer of the stack and which implements the appropriate action indicated within the ETT and stores the message information provided by the ETT within a log maintained by that layer.

19. The computer program product of claim 16, further comprising program code for:
on receipt of the ETT at each intervening layer and by the second component, evaluating the second information set of the ETT to determine whether an action is required; and
when an action is required, implementing the required action provided within the second information set at each intervening layer and at the second component.

20. The computer program product of claim 19, further comprising program code for:
creating a log entry of the error and corresponding action when a pre-defined criterion for logging the error and corresponding action is met; and
enabling user access to the log of each layer of the stack, such that said user is able to review log entries immediately before and after the message for unusual events, and determine the source, timing and cause of each recorded error.
